(19) United States
(12) Patent Application Publication
(10) Pub. No.: US 2021/0007321 A1
(43) Pub. Date: Jan. 14, 2021

(54) ANIMAL CARRIER HAVING ABSORBENT CARRYING PANEL

(71) Applicant: Rachel Ceretto, Santa Monica, CA (US)

(72) Inventor: Rachel Ceretto, Santa Monica, CA (US)

(21) Appl. No.: 16/508,159

(22) Filed: Jul. 10, 2019

(51) Int. Cl. A01K 1/02

(52) U.S. Cl. CPC A01K 1/029; A01K 1/0254

(57) ABSTRACT

Animal carriers for transporting animals, such as pets are described. An animal carrier includes one or more carrier portions, such as a carrying panel, having an absorbent fabric that allows the carrier to be used to dry or clean the animal. The animal carrier includes several straps attached at the front and rear edges of the carrying portion to allow the carrier to be carried over the shoulder and to provide stability for the animal in the carrier. The carrier has an opening to allow the animal to see its surroundings and owner. Other embodiments are also described and claimed.

### BACKGROUND

### Field

Embodiments related to animal carriers are disclosed. More particularly, embodiments related to animal carriers having shoulder straps are disclosed.

### Background Information

Pets travel with their owners to a variety of destinations, including groomers, veterinarians, parks, and beaches. Animals, such as pets can be carried to such destinations in animal carriers, which typically include a carrying portion to hold the pet, and one or more handles attached to the carrying portion for the owner to hold. The animal carriers secure the animal to prevent separation from the owner, as well as allow the pet to both feel secure and see outside the carrier, which can provide a more pleasant trip for the animal.

### SUMMARY

Existing animal carriers have straps that are worn over the back or single straps attached to the front or back of the carrier. The carrying portions of the animal carriers typically enclose the entire pet, and do not allow the pet to see outside of the animal carrier while being carried. Furthermore, existing animal carriers are constructed of non-absorbent materials that may be visually appealing, but which can cause a wet animal to remain wet for prolonged periods of time after, e.g., a beach excursion.

An animal carrier that is multi-functional is provided. More particularly, the animal carrier can be used to carry and dry an animal, such as a pet. In an embodiment, the animal carrier includes a carrying panel having a front edge defining a front opening and rear edge defining a rear opening when the carrying panel is curled around a pet. The front opening is supported by a shoulder strap such that the pet is able to see forward while being carried. Furthermore, a rear panel can cover the rear opening to hold the pet securely and comfortably while being carried. An entirety or a portion of the animal carrier can be constructed from absorbent material. For example, the carrying panel, the shoulder strap, the rear panel, or any other portion of the animal carrier can be fabricated from an absorbent material, e.g., a terry-cloth fabric. The absorbent material can allow the animal carrier to be used as a towel to dry the pet after an excursion, e.g., to the beach, and can continue to wick moisture away from the pet when the pet is being carried home.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and such references mean at least one. Also, in the interest of conciseness and reducing the total number of figures, a given figure may be used to illustrate the features of more than one embodiment of the invention, and not all elements in the figure may be required for a given embodiment.

FIG. 1 is a front perspective view of an animal carrier, in accordance with an embodiment.

FIG. 2 is a front view of an animal carrier, in accordance with an embodiment.

FIG. 3 is a side view of an animal carrier, in accordance with an embodiment.

FIG. 4 is a rear perspective of the animal carrier, in accordance with an embodiment.

FIG. 5 is a pictorial view of a pet being carried within an animal carrier, in accordance with an embodiment.

FIG. 6 is a rear perspective of an animal carrier having a rear panel opening, in accordance with an embodiment.

FIG. 7 is a rear perspective of an animal carrier having shoulder strap supports, in accordance with an embodiment.

FIG. 8 is a rear perspective of the animal carrier having an accessory clip, in accordance with an embodiment.

### DETAILED DESCRIPTION

Embodiments describe an animal carrier having an absorbent carrying panel. The animal carrier can be used to transport a dog. The animal carrier may, however, be used in other applications, such as to transport cats or other pets.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “distal” may indicate a first direction away from a reference point, e.g., away from a carrying panel. Similarly, “proximal” may indicate a location in a second direction opposite to the first direction. Such terms are provided to establish relative frames of reference, however, and are not intended to limit the use or orientation of an animal carrier to a specific configuration described in the various embodiments below.

In an aspect, an animal carrier is multifunctional. The multifunctional animal carrier can be used to hold a pet during transportation, and can be fabricated at least in part by an absorbent material that allows the animal carrier to also be used as a towel or a blanket.

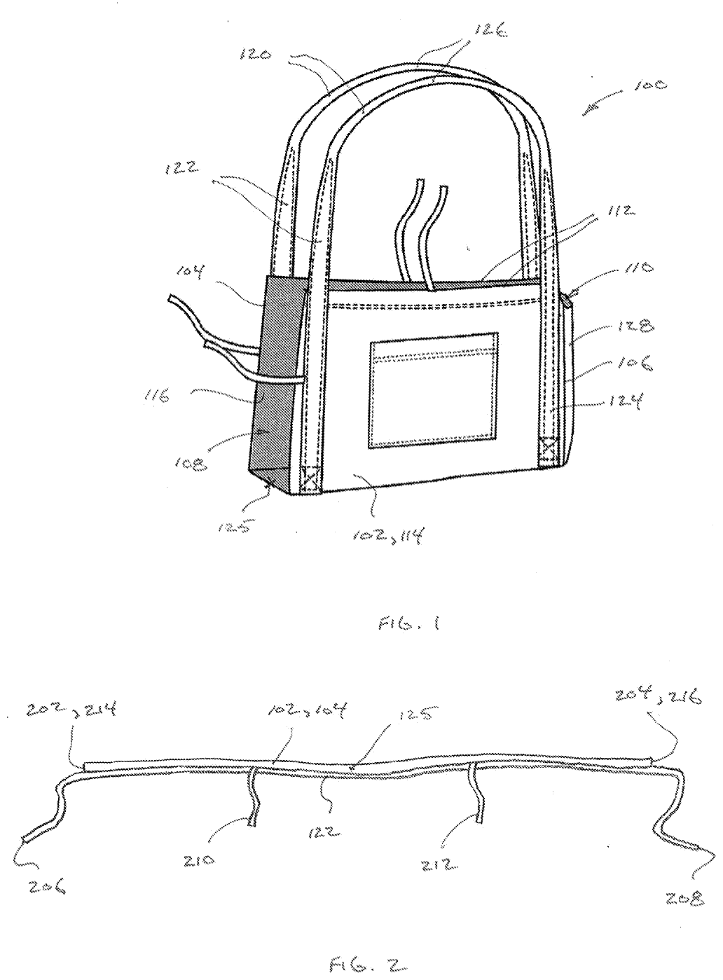

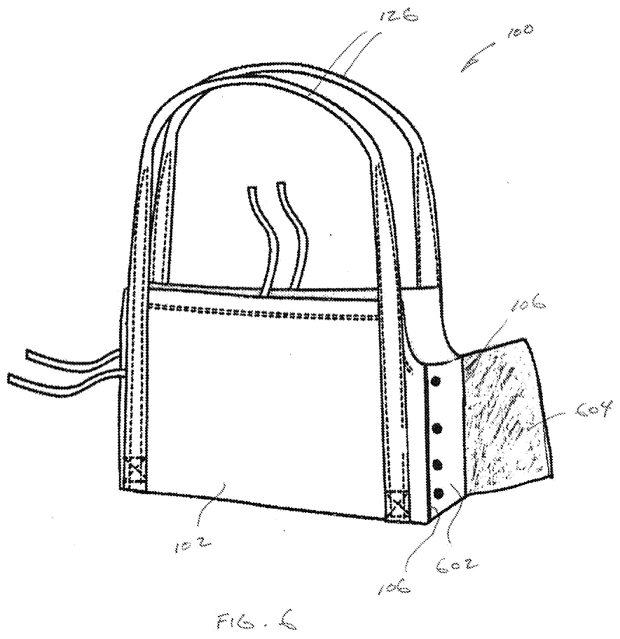

Referring to FIG. 1, a front perspective view of an animal carrier is shown in accordance with an embodiment. An animal carrier 100 can include a carrying panel 102 to hold the pet while transporting the pet from one place to another. The carrying panel 102 can, for example, be a sheet of cloth or fabric that can be folded around the pet to contain and comfort the pet during travel. In an embodiment, the carrying panel 102 has a front edge 104 and a rear edge 106. The front edge 104 can be a forward facing edge of the panel that defines the front opening 108 when the carrying panel 102 is curled around the pet. By contrast, the rear edge 106 can define a rear opening 110 when the carrying panel 102 is curled around the pet. Accordingly, the front edge 104 can effectively be curled into a U-shape that allows the forward-facing pet to hang its paws out of the animal carrier 100 while also viewing a surrounding environment through the front opening 108 (FIG. 5).

The carrying panel 102 is shown as a single layer of fabric, however, it will be appreciated that the carrying panel 102 may have several layers of fabric. For example, the carrying panel 102 can include a second, inner layer of fabric that acts as a water barrier to keep a user dry while carrying a wet animal. The fabric layers may be formed from a same or different material. The fabric layers may be surface treated. For example, an inner surface of the inner layer of material (which may be the only layer of material) can be coated with an antibacterial coating. A portion or an entirety of the animal carrier 100 surfaces can be so treated to reduce a likelihood of bacterial growth on the animal carrier 100.

The front edge 104 and the rear edge 106 of the carrying panel 102 may be interconnected by a pair of lateral edges 112 extending rearward from the front edge 104 to the rear edge 106. Whereas the lateral edges 112 can interconnect the front edge 104 and the rear edge 106, one or more of the front edge 104 or the rear edge 106 can extend between the lateral edges 112. For example, the front edge 104 can extend between the lateral edges 112 to define the front opening 108 when the carrying panel 102 is curled around the pet. Similarly, the rear edge 106 can extend between the pair of lateral edges 112 to define the rear opening 110.

Still referring to FIG. 1, the carrying panel 102 can be a single sheet of material that extends between the front edge 104, the rear edge 106, and the lateral edges 112. For example, the carrying panel 102 can be a solid rectangular panel such that the front edge 104 and the rear edge 106 meet the lateral edges 112 at corners. The edges can be orthogonal to each other at the corners, or the corners can be rounded or chamfered, by way of example. In any case, the edges can extend such that, when the carrying panel 102 is curled around the pet, the front edge 104 forms the front opening 108 around a front of the pet, and the lateral edges 112 extend rearward effectively parallel with an axis extending from a head to a tail through the body of the pet. More particularly, in the curled configuration, the carrying panel 102 wraps around a longitudinal axis that extends in the forward direction through the front opening 108. The single sheet of material can have an outer surface 114 facing the surrounding environment, and an inner surface 116 facing inward toward the longitudinal axis (and the pet) when the pet is being carried.

In an embodiment, the carrying panel 102 is flexible, and a flexibility of the carrying panel 102 can correspond to a size of the animal that is to be carried. For example, an animal carrier 100 sized to carry a medium-sized dog may be less flexible than an animal carrier 100 sized to carry a small-sized dog.

An entirety or a portion of the animal carrier 100 can be constructed from absorbent materials, synthetic fabrics, or recycled fabrics, as described below. For example, the carrying panel 102 (or a shoulder strap, a rear panel, or any other portion of the animal carrier 100, as described below) can be fabricated from an absorbent material. In an embodiment, the carrying panel 102 is at least partially fabricated from an absorbent material. The absorbent material can be cotton, paper, poly(vinyl acetate), or another natural or synthetic material having absorbent properties. For example, the absorbent material can be a nylon or flashspun high-density polyethylene fibers, to name only a few possibilities. The absorbent material can be made from recycled plastics. For example, chips of recycled polyester can be included in and/or used to construct the absorbent material. The absorbent material may also be a blend of materials, such as a polyblend, e.g., a fleece or microfiber blend. In an embodiment, the absorbent material is inexpensive. The carrying panel 102 can form a majority of the animal carrier 100, e.g., may have more exposed surface area than the other components of the animal carrier 100, and thus, the animal carrier 100 can be manufactured inexpensively. Furthermore, a majority of the animal carrier 100 can be absorbent, however, as described below, at least some portion of the animal carrier 100 may be non-absorbent or less absorbent than the carrying panel 102.

The absorbent material can be in a variety of material forms. For example, the absorbent material can be made into an absorbent fabric, and thus, the carrying panel 102, or any other portion of the animal carrier 100, can include an absorbent fabric. Examples of absorbent fabrics include as a terry-cloth material or fabric, cotton flannel, chamois, etc. The absorbent fabric can include and/or be formed from recycled polyester chips. Accordingly, known weaving, knitting, and other textile processes can be used to form the absorbent carrying panel 102. For example, the carrying panel 102 can have a same structure as a beach towel.

The animal carrier 100 can include one or more shoulder straps 120 to allow a user to suspend and support a carrying panel 102 comfortably when transporting pet. The shoulder strap 120 can include an absorbent material or fabric, which may be a same or different absorbent fabric, e.g., a terry-cloth material, used for the carrying panel 102. Alternatively, the shoulder strap 120 may be fabricated from a non-absorbent or less absorbent material than the carrying panel 102.

The shoulder strap 120 can be a continuous length of material having several portions. A front strap portion 122 of the shoulder strap 120 can connect to the outer surface 114 of the carrying panel 102 along the front edge 104. For example, the front strap portion 122 can extend parallel to the front edge 104 from a lateral edge 112 toward a midpoint 125 of the front edge 104. The midpoint 125 is reference geometry, which during transportation of the pet, would be located on the carrying panel 102 below the pet. The front strap portion 122 can be sewed, adhered, or otherwise bonded to the outer surface 114 of the carrying panel 102. Alternatively, the front strap portion 122 can be attached to the inner surface 116 of the carrying panel 102 using similar processes.

A rear strap portion 124 of the shoulder strap 120 can connect to the outer surface 114 of the carrying panel 102 along the rear edge 106. For example, the rear strap portion 124 can extend parallel to the rear edge 106 from a lateral edge 112 toward a midpoint of the rear edge 106 (not shown). The midpoint of the rear edge 106 is reference geometry longitudinally aligned with the midpoint 125 of the front edge 104. The rear strap portion 124 can be sewed, adhered, or otherwise bonded to the outer surface 114 of the carrying panel 102. Alternatively, the rear strap portion 124 can be attached to the inner surface 116 of the carrying panel 102 using similar processes.

The shoulder strap 120 can include one or more handle portions 126 extending from the front strap portion 122 to the rear strap portion 124. More particularly, the handle portions 126 can be segments of the shoulder strap 120 that are held by a user while carrying the pet. The handle portions 126 can have predefined arc shapes, or may be flexible straps that have no predefined shape. In any case, the handle portions 126 can be separated to open the carrying panel 102, drawn toward each other to close the carrying panel 102, and lifted to suspend the carrying panel 102 and the pet.

In an embodiment, the animal carrier 100 can include a rear panel 128 to cover the rear opening 110 that is defined by the rear edge 106. More particularly, the rear panel 128 can be attached to the carrying panel 102 along the rear edge 106, and can extend orthogonal to the longitudinal axis. That is, the longitudinal axis of the enclosed volume within the carrying panel 102 can extend through the rear panel 128 when the pet is being carried. As such, the rear panel 128 provides a backstop to the pet to comfortably press against the pet as it is being carried and to reduce a likelihood that the pet will slide backward and fall from the animal carrier 100. The rear panel 128 is described in more detail below.

It will be appreciated that the animal carrier 100 can include a front panel (not shown) that is similar to the rear panel 128. More particularly, the front panel can cover the front opening 108 to define a front boundary of the enclosed volume within the carrying panel 102. Accordingly, an animal can be placed into the enclosed volume and surrounded by the front panel, the carrying panel 102, and the rear panel 128.

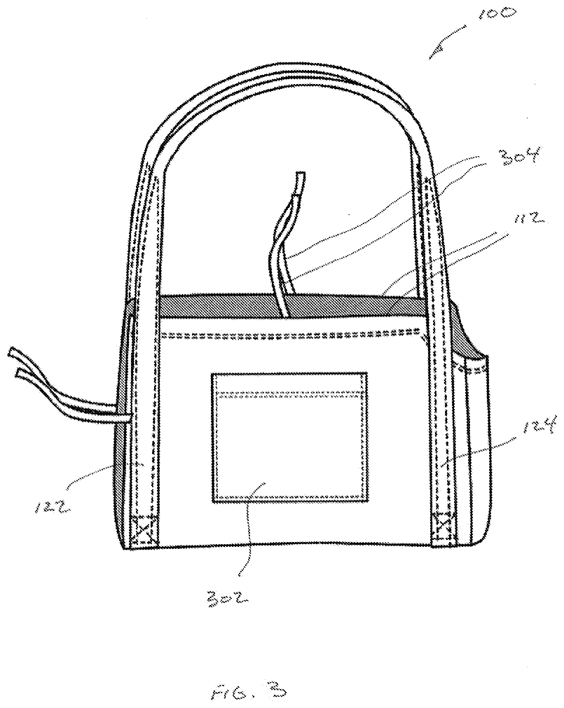

Referring to FIG. 2, a front view of an animal carrier is shown in accordance with an embodiment. One or more of the front strap portion 122 or the rear strap portion 124 of the shoulder strap 120, which connect to the carrying panel 102 respectively along the front edge 104 and the rear edge 106, may extend continuously along the respective edge between the lateral edges 112. For example, the front strap portion 122 can extend continuously along the front edge 104 between the pair of lateral edges 112 such that the front strap portion 122 supports the pet when the shoulder strap 120 is suspended. Similarly, the rear strap portion 124 can extend underneath and around a bottom portion of the outer surface 114 and the pet when the pet is being carried. As such, the strap portions can go along the entire bottom of the carrying panel 102, from a first lateral edge 202 to a second lateral edge 204.

In an embodiment, the strap portions, e.g., the front strap portion 122, extend continuously along the bottom of the carrying panel 102. For example, there may be no seams or discontinuities between segments of the front strap portion 122 that connect to the handle portions 126. That is, the first strap portion can extend from a first strap end 206 to a second strap end 208. The first strap end 206 can be a transition point between the front strap portion 122 and a first, e.g., a left, handle portion 126. Similarly, the second strap end 208 can be a transition point between the front strap portion 122 and a second, e.g., a right, handle portion 126. Continuous straps along the bottom surface of the carrying panel 102 can evenly and efficiently distributed a weight of the pet. Accordingly, the shoulder strap 120 may be less likely to break when a heavy pet is carried.

In an alternative embodiment, the strap portions (the front strap portion 122 or the rear strap portion 124) may be discontinuous. For example, as shown in FIG. 1, the front strap portion 122 can include several segments. A first segment of the front strap portion 122 can be connected to a first, e.g., the left, handle portion 126, and a second segment of the front strap portion 122 can be connected to a second, e.g., the right, handle portion 126. Each of the segments can be attached to the carrying portion at respective strap ends nearer to the midpoint 125 than the lateral edges 112, as shown by the reinforced X-shaped stitches in FIG. 1. One skilled in the art will understand that other stitch patterns may be used, and thus, the X-shaped stitches are illustrative and not limiting. It will be appreciated, however, that any of the stitching of the animal carrier 100 can be reinforced to ensure security and safety of the animal during transportation.

Referring again to FIG. 2, a front of an animal carrier 100 is shown in accordance with an embodiment. In an embodiment, the animal carrier 100 includes a first tie 210 and a second tie 212 connected to the front edge 104 of the carrying panel 102. For example, the first tie 210 can be between the midpoint 125 and a first end 214 of the front edge 104, and the second tie 212 can be between the midpoint 125 and a second end 216 of the front edge 104. Placing the ties on either side of the midpoint 125, which is between the first end 214 and the second end 216, ensures that when the carrying panel 102 is curled around the pet and the midpoint 125 rests beneath the pet, the ties can extend laterally toward each other to tie a knot in front of the pet. The first tie 210 and the second tie 212 may include or be fabricated from the absorbent material used to construct the carrying panel 102, e.g., the absorbent fabric such as terry-cloth material, which can be pliable. Accordingly, the ties can be absorbent, easily tied, and in the tied configuration can retain the pet within the animal carrier 100 to reduce a likelihood that the pet will escape the animal carrier 100 while being carried.

Each tie may be attached to the carrying panel 102 midway between the midpoint 125 and a respective lateral edge 112 of the carrying panel 102. For example, the first tie 210 can be one half of a distance between the midpoint 125 and the first end 214, and the second tie 212 can be one half of a distance between the midpoint 125 and the second end 216. As described above, the ties can be tied together to provide stability to the animal. Placement of the ties at the midway point can also allow the animal to see outside the carrier. That is, the ties positioned in such a manner can join at a knot that is below a line of sight of the pet while resting in the animal carrier 100.

In an embodiment, the ties may be attached to the carrying panel 102 nearer to the midpoint 125 than the respective end. For example, the first tie 210 may be attached to the carrying panel 102 nearer to the midpoint 125 than the first end 214 and the second tie 212 may be attached to the carrying panel 102 nearer to the midpoint 125 than the second end 216. In an embodiment, the first tie 210 is attached to the carrying panel 102 at a distance from the first end 214 that is two-thirds of the distance between the first end 214 and the midpoint 125. Similarly, the second tie 212 can be attached to the carrying panel 102 at a distance from the second end 216 that is two-thirds of the distance between the second end 216 and the midpoint 125. Accordingly, the first and second ties 212 can be tied together to provide stability to the animal and allow the animal to see outside the carrier. As described above, the ties may be absorbent, or alternatively, the ties may be fabricated from a non-absorbent or less absorbent material than the carrying panel 102.

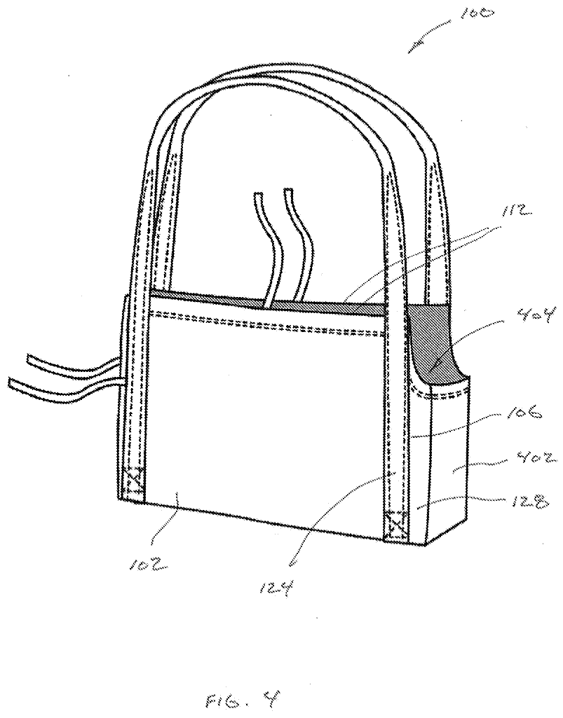

Referring to FIG. 3, a side view of an animal carrier is shown in accordance with an embodiment. In an embodiment, the animal carrier 100 includes one or more pockets 302. For example, a pocket 302 can be placed on the outer surface 114 of the carrying panel 102 longitudinally between the front strap portion 122 and the rear strap portion 124. The pocket 302 can be made of the same absorbent material as the carrying portion, and may be attached with stitching to the outer surface 114 of the carrying portion. The pocket 302 can be sized and configured to carry pet care items, such as a brush, or personal items, such as a water bottle. In an embodiment, the animal carrier 100 includes several pockets 302, e.g., a second pocket 302 on the outer surface 114 of the carrying panel 102 opposite of the pocket 302 illustrated in FIG. 3.

Other features may be incorporated into the animal carrier 100 by one skilled in the art. For example, the animal carrier 100 can include one or more top ties 304 attached to the carrying panel 102 along the lateral edges 112. The top ties 304 can be used in a manner similar to the first tie 210 and the second tie 212 attached along the front edge 104. More particularly, the top ties 304 can be used to tie a knot above the pet to further secure the pet within the animal carrier 100 during transport. In an embodiment, each top tie 304 is attached to a respective lateral edge 112 at a location that is midway between the front strap portion 122 and the rear strap portion 124. Alternatively, the ties may be located forward or behind such middle location.

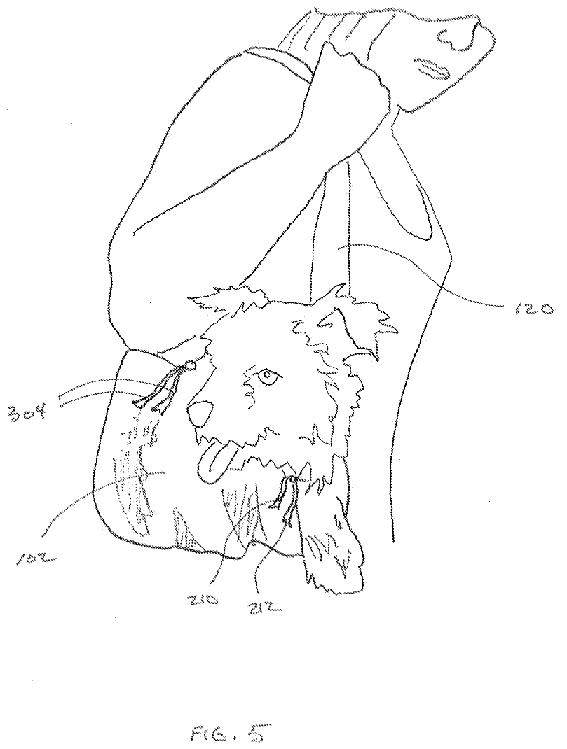

Referring to FIG. 4, a rear perspective of the animal carrier is shown in accordance with an embodiment. The rear strap portion 124 may be offset from a rear surface 402 of the rear panel 128. Placing the supportive strap in such a location can allow the haunches of the pet to be supported effectively by the rear strap portion 124, and can allow the rear of the pet to extend backward into a pouch portion 404 that is formed by the rear panel 128. More particularly, the pouch portion 404 can contain the rear of the pet and act as a backstop to prevent the pet from sliding out of the animal carrier 100.

The rear panel 128 can be attached to the carrying panel 102 along the rear edge 106 of the carrying panel 102. The rear panel 128 may be of equal height to the lateral edges 112 of the carrying portion. Alternatively, the rear panel 128 may be shorter than the lateral edges 112. For example, a curved edge can extend downward and rearward from the lateral edges 112 to a top edge of the rear panel 128. Accordingly, the carrying portion can provide additional room to allow the pet to lie comfortably within the animal carrier 100.

Referring to FIG. 5, a pictorial view of a pet being carried within an animal carrier is shown in accordance with an embodiment. One or more animals, e.g., pet(s), can be placed on the carrying panel 102 and the panel can be folded around the pet(s). For example, several small dogs can be carried in the animal carrier 100 (assuming the panels are sufficiently large) or a single animal can be carried as shown. Once the animal has been placed in the carrier, the user can tie the ties, e.g., the first tie 210 and the second tie 212 and/or the top ties 304 to secure the animal within the animal carrier 100. The carrying panel 102 can fold around the pet and the pet can lie comfortably with paws hanging over the front edge 104 and rear end supported by the rear panel 128. The user can lift the animal carrier 100 by the shoulder straps 120 to carry the pet to a destination. In the event that the pet become wet, the user can use the animal carrier 100, e.g., the carrying portion or any other portion of the animal carrier 100 that is formed from absorbent material, as a towel to dry or clean the pet.

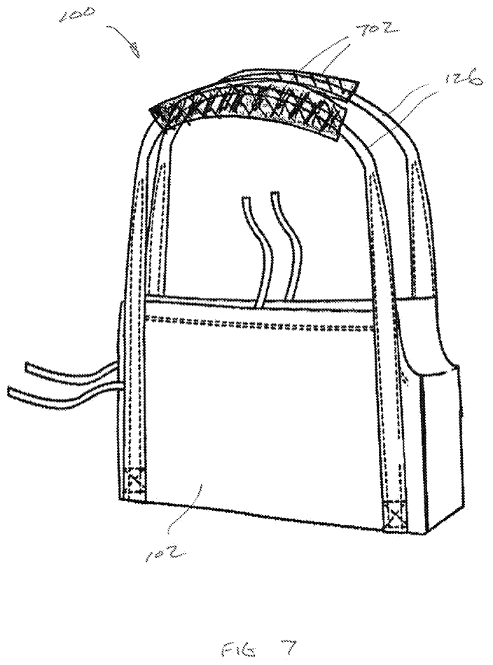

Referring to FIG. 6, a rear perspective of an animal carrier having a back panel opening is shown in accordance with an embodiment. The rear panel 128 may open to allow the animal carrier 100 to be laid flat on the ground. For example, the rear panel 128 can be formed by two overlapping panels, e.g., a first rear panel 602 and a second rear panel 604. The rear panels 602, 604 can be flaps that extend rearward from the rear edge 106 of the carrying panel 102. The rear panels 602, 604 can be folded inward to overlap. While overlapping, first rear panel 602 can be fastened to second rear panel 604 by one or more fastening mechanisms. For example, the rear panels 602, 604 can be secured by a zipper, buttons, or clasps. The fasteners can be distributed along the rear edge 106 as shown, or may be located anywhere else on one or more of the rear panels 602, 604. When the panels are fastened together, they combine to form rear panel 128. When the panels are unfastened, the handle portions 126 can be splayed apart to open the animal carrier 100 into a blanket-like configuration that lies flat on the ground.

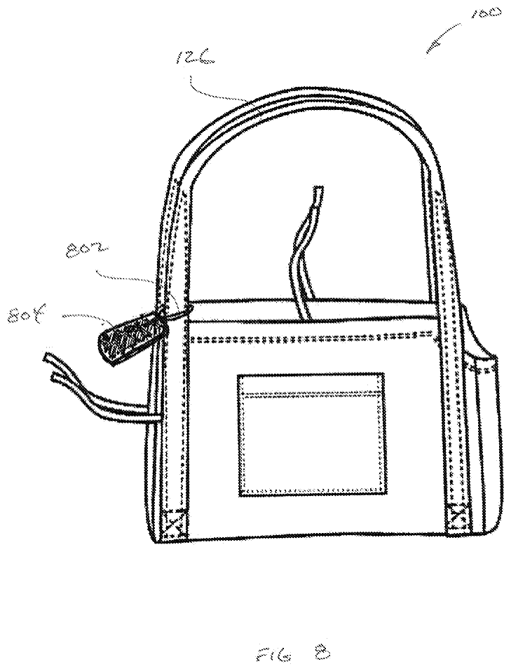

Referring to FIG. 7, a rear perspective of an animal carrier having shoulder strap supports is shown in accordance with an embodiment. The handle portions 126 can include additional support to reduce a likelihood that the handle portions 126 will slip off a user's shoulders when the user is carrying the animal carrier 100. More particularly, the handle portions 126 can be used as shoulder straps, and may include one or more strap supports 702 located along the handle portions 126 where the straps will rest on the user's shoulders. The strap supports 702 provide additional material that increases surface contact against the user's shoulders, and thus, increases friction to retain the animal carrier 100 on the user's shoulder during transportation.

Referring to FIG. 8, a rear perspective of the animal carrier having an accessory clip is shown in accordance with an embodiment. The animal carrier 100 can include one or more clips to fasten and retain various items. For example, a clip 802 can be attached to one or more of the handle portions 126. In an embodiment, the clip 802 can be attached to an animal's collar to restrain the animal and reduce a likelihood that the animal will attempt to jump out of the animal carrier 100 during transport. Alternatively or additionally, the clip can be used to fasten personal items, such as an identification tag 804, a water bottle, a water bowl, a chew toy, etc.

Other modifications are contemplated. For example, the carrying panel 102 may include several holes, e.g., four holes, positioned to receive the legs of an animal when the animal is being carried. In such case, the animal's feet can be inserted through the holes and the carrying panel 102 can be wrapped around the body of the animal such that the feet dangle while the animal is being carried.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An animal carrier, comprising:
a carrying panel including an absorbent fabric and having a front edge and a rear edge, wherein the front edge defines a front opening and the rear edge defines a rear opening when the carrying panel is curled around a pet;
a shoulder strap including a front strap portion attached to an outer surface of the carrying panel along the front edge, a rear strap portion extending over the outer surface along the rear edge, and one or more handle portions extending from the front strap portion to the rear strap portion; and
a rear panel attached to the carrying panel along the rear edge, wherein the rear panel covers the rear opening.

2. The animal carrier of claim 1, wherein the carrying panel is a solid rectangular panel.

3. The animal carrier of claim 1, wherein the absorbent fabric includes an absorbent material selected from a group consisting of a terry-cloth material and a recycled polyester material.

4. The animal carrier of claim 1, wherein the shoulder strap includes the absorbent fabric.

5. The animal carrier of claim 4, wherein the absorbent fabric includes a terry-cloth material.

6. The animal carrier of claim 1 further comprising a first tie and a second tie, wherein the front edge has a midpoint between a first end and a second end, wherein the first tie is attached to the carrying panel at the front edge between the first end and the midpoint, and wherein the second tie is attached to the carrying panel at the front edge between the second end and the midpoint.

7. The animal carrier of claim 6, wherein the first tie is attached to the carrying panel nearer to the midpoint than the first end, and wherein the second tie is attached to the carrying panel nearer to the midpoint than the second end.

8. The animal carrier of claim 7, wherein the first tie and the second tie include the absorbent fabric.

9. The animal carrier of claim 8, wherein the absorbent fabric includes a terry-cloth material.

10. An animal carrier, comprising:
a carrying panel including a single sheet of absorbent fabric and having a front edge and a rear edge, wherein the front edge defines a front opening and the rear edge defines a rear opening when the carrying panel is curled around a pet;
a shoulder strap including a front strap portion extending over an outer surface of the carrying panel along the front edge, a rear strap portion extending over the outer surface along the rear edge, and one or more handle portions extending from the front strap portion to the rear strap portion; and
a rear panel attached to the carrying panel along the rear edge, wherein the rear panel covers the rear opening.

11. The animal carrier of claim 1, wherein the absorbent fabric includes a terry-cloth material.

12. The animal carrier of claim 11, wherein the shoulder strap includes the terry-cloth material.

13. The animal carrier of claim 12 further comprising a first tie and a second tie, wherein the front edge has a midpoint between a first end and a second end, wherein the first tie is attached to the carrying panel at the front edge between the first end and the midpoint, and wherein the second tie is attached to the carrying panel at the front edge between the second end and the midpoint.

14. The animal carrier of claim 13, wherein the first tie is attached to the carrying panel nearer to the midpoint than the first end, and wherein the second tie is attached to the carrying panel nearer to the midpoint than the second end.

15. The animal carrier of claim 14, wherein the first tie and the second tie include the terry-cloth material.

16. An animal carrier, comprising:
a carrying panel including a terry-cloth fabric and having a front edge extend between a pair of lateral edges, wherein the front edge defines a front opening when the carrying panel is curled around a pet; and
a shoulder strap including a front strap portion extending continuously along the front edge between the pair of lateral edges such that the front strap portion supports the pet when the shoulder strap is suspended.

17. The animal carrier of claim 16, wherein the carrying panel is a single sheet of the terry-cloth fabric.

18. The animal carrier of claim 17, wherein the shoulder strap includes the terry-cloth fabric.

19. The animal carrier of claim 18 further comprising a first tie and a second tie, wherein the front edge has a midpoint between the pair of lateral edges, wherein the first tie is attached to the carrying panel at the front edge between a first lateral edge and the midpoint, and wherein the second tie is attached to the carrying panel at the front edge between a second lateral edge and the midpoint.

20. The animal carrier of claim 19, wherein the first tie is attached to the carrying panel nearer to the midpoint than the first lateral edge, and wherein the second tie is attached to the carrying panel nearer to the midpoint than the second lateral edge.
